(19) United States
(12) Patent Application Publication
(10) Pub. No.: US 2008/0288563 A1
(43) Pub. Date: Nov. 20, 2008

(54) Allocation and redistribution of data among storage devices

(76) Inventors: Foster D. Hinshaw, Somerville, MA (US); Craig S. Harris, Acton, MA (US); Timothy J. Bingham, Westford, MA (US); Alan Potter, Newton, MA (US)

Correspondence Address: GOODWIN PROCTER LLP;PATENT ADMINISTRATOR, EXCHANGE PLACE, BOSTON, MA, 02109-2881, US

(21) Appl. No.: 12/152,419

(22) Filed: May 14, 2008

Related U.S. Application Data
(60) Provisional application No. 60/930,103, filed on May 14, 2007.

(51) Int. Cl. G06F 17/30

(52) U.S. Cl. 707/205; 707/E17.01

(57) ABSTRACT

Distributing and redistributing records among a changing set of storage devices is accomplished by grouping the records based on the starting and ending numbers of storage devices.

### CROSS-REFERENCE TO RELATED APPLICATIONS

This application claims priority to and the benefits of U.S. provisional patent application Ser. No. 60/930,103, filed on May 14, 2007, the entire disclosure of which is incorporated herein by reference.

### TECHNICAL FIELD OF THE INVENTION

This invention relates generally to systems for storing computer data, and more specifically to systems for managing the distribution of records within a network of storage devices.

### BACKGROUND

Database systems are used to store and provide data records to computer applications. In a massively parallel-processing database system (referred to herein as an “MPP-DB”), data retrieval performance can be improved by partitioning records among multiple storage devices. These storage devices may be organized, or example, as a collection of network-attached storage (NAS) appliances, which allow multiple computers to share data storage devices while offloading many data-administration tasks to the appliance. General-purpose NAS appliances present a file system interface, enabling computers to access data stored within the NAS in the same way that computers would access files on their own local storage.

A network-attached database storage appliance is one type of NAS, used for storage and retrieval of record-oriented data used by a database management systems (DBMS) that typically support applications. In such cases, the general-purpose file system interface is replaced with a record-oriented interface, such as an application programming interface that supports one or more dialects of a structured query language (SQL). Because the unit of storage and retrieval is a record, rather than a file, a network-attached database storage appliance typically controls concurrent access to individual records. In addition, the network-attached database storage appliance may also provide other management functions such as compression, encryption, mirroring and replication.

In the most general case in which an MPP-DB stores R records among D storage devices, the time required to execute a query that examines each record is optimally on the order of R/D. By increasing the number of storage devices, performance can be improved.

System-wide optimal query-processing times (i.e., R/D retrieval) can only be achieved if the R records are evenly distributed among the D storage devices. If the distribution of the records is skewed such that one storage device contains more records than another, then that device becomes a performance bottleneck for the entire MPP-DB.

Conventionally, there are two techniques for obtaining an even distribution of records among storage devices. One technique, referred to herein as “attribute-based distribution,” distributes records based on attributes of the records themselves (e.g., dates, text values, update frequency, etc.). Table partitioning techniques used in relational database management systems (RDBMSs) is one example of attributed-based data distribution. Such systems partition records according to values in certain fields (i.e., records are assigned to the partitions based on values of one or more of attributes or values of the fields), and partitions are then mapped to storage devices. The second approach for distributing data among devices does not depend on the attributes of the records, and instead distributes records randomly or in “round-robin” fashion—e.g., according to the order in which records are created. As an example, the first record created is stored on the first storage device, the second record on the second device and so on. This technique can be generalized to storing the Nth record on the (N modulo D)th storage device.

In an MPP-DB, the number of storage devices may change over time as data is added to and removed from the database. When new storage devices are added, the distribution of existing records becomes skewed, as there are initially no records on the new storage devices. To achieve optimal performance, the existing records must be redistributed across the newly expanded set of storage devices. One conventional method for accomplishing this is to reload all of the records, which is costly and time consuming because MPP-DBs typically include many storage devices and a very large number of records. Unloading and reloading may require a considerable amount of intermediate storage, which comes at a cost. Furthermore, while only a small fraction of the existing records may need to be redistributed to restore balance, the reload method requires redistributing all the records, which takes much more time than would be required to redistribute a small fraction. There is a need for a redistribution process that moves a minimal set of records from existing storage devices to new storage devices, and that ensures that the resulting distribution is evenly balanced.

There exist numerous techniques for determining the number of records to be redistributed from an existing set of storage devices to a new set of storage devices while maintaining an even distribution across the new set. For example, given a number of existing storage devices E and an additional increment of new storage devices N, the proportion of records to be redistributed from each existing device to each new device is

$$\frac{1}{E + N} .$$

Similarly, if S devices are being subtracted from an array of E existing storage devices,

$$\frac{1}{E - S}$$

percent of the records should be redistributed from each of the S subtracted storage devices to each of the remaining (E-S) storage devices.

Any technique that redistributes the appropriate proportion of records to the proper target storage device will avoid skew, and provide optimal performance for queries that examine all the records or a subset of the records that is substantially random with respect to the distribution method. But while the aggregate percentage of records to redistribute is important, the choice of which particular records to redistribute can also have a significant affect on the resulting performance of the system.

To illustrate the effect of choosing particular sets of records, suppose R/D records are distributed on each of D storage devices, using the round-robin, order-of-creation distribution method explained above. Further, suppose that the number of storage devices is set to double from D to 2D, suggesting that half the records from each of the existing D storage devices should be moved to the new devices. There exist numerous ways to achieve an even redistribution, such as redistributing every other record, distributing the first R/2D records or distributing the last R/2D records. While each of these techniques may produce evenly distributed data in the aggregate, each has flaws.

For example, if the records were stored sequentially at consecutive storage locations, then redistributing every other record leaves ‘holes’ in the storage space of the existing D storage devices. These holes result in fragmented storage and cause performance degradation. The holes could be filled with new records over time, but until they are, the existing storage devices would operate more slowly than the new devices, even though each contains the same number of records.

Moving the first or the last R/2D records avoids the fragmentation problem above, but has other drawbacks. The first R/2D records are the oldest records, whereas the last R/2D records are the most recently created records. Redistributing the oldest records results in the original D storage devices containing all of the most recently created records, whereas the new storage devices will contain only the oldest records. Conversely, redistributing the newest records results in the original D storage devices containing all of the oldest records, and the new storage devices containing the newest records. Using these approaches, for any query (e.g., data retrieval request, deletion, or update) that operates on records according to their age or recency, up to half of the 2D storage devices will likely contain no matching records. In other words, even though the total number of records is not skewed across the resulting number of storage devices, the number of records applicable to age-based queries is severely skewed.

The choice of which records to redistribute is also important for distribution schemes that depend on record attributes. Consider a distribution method that uses a hashing function to map one or more attribute values of the records to a resulting number ‘N’ which is mapped to a particular storage device, for example by using the residue of (N modulo D) as an index to the D storage devices.

Query processors for MPP-DBs use this approach of mapping hash values to storage devices in order to direct queries only to those storage device(s) that may contain a matching record. For example, suppose a particular hash-based partitioning scheme distributes records having an attribute value of ‘abc’ to storage device #3. An intelligent query processor would then direct any retrieval requests for records with an attribute value of ‘abc’ to storage device #3, and not to any other storage device. Although there is no guarantee that any records matching the query (i.e., that have ‘abc’ in the particular attribute field) exist on storage device #3, it is certain that no other storage device has such records. By not sending the retrieval request to each of the D storage devices, the overall throughput performance of the MPP-DB is improved, as the storage devices that cannot contain applicable records are not addressed and remain free to work on other retrieval requests.

Using this approach, the mapping of hash values to storage devices must be altered when storage devices are added to or removed from an original set of D storage devices. In addition to the skew-avoidance requirement of distributing the hash values evenly across the new number of devices, there is also a requirement of functional determination—that is, a hash value is deterministically mapped to a single storage device, whether it be the original device or a new device.

These and other shortcomings of existing data-allocation and distribution methods give rise to the need for improved techniques for redistributing records across a changing set of storage devices without skew fragmentation or loss of functional determinacy.

### SUMMARY OF THE INVENTION

The present invention facilitates the distribution and reallocation of data records among a set of storage devices. More specifically, using the techniques described herein, records can be written to and moved among multiple storage devices in a manner that balances processing loads among the devices, compensates when devices are sent offline, and redistributes data when new devices are brought online.

In one aspect, a method of allocating a set of data records among data storage devices includes the steps of defining a series of group values based on the number of devices; assigning each group value to a substantially equal number of the data records; assigning each group value to one of the devices in the system; and storing each of the data records on the device having a group value corresponding to the group value of the data record.

In one embodiment, a record allocation table is defined. The number of rows in the table corresponds to the maximum possible number of storage devices that may be present in the system. The values in the table direct the initial grouping and subsequent regrouping of records among storage devices as the number of devices changes. The record allocation table typically include cells that represent an intersection of one of N rows and M columns, where N is the maximum possible number of storage devices in the system and M represents the lowest common multiple of a series of numbers from 1 to N. A “group value” based on the number of storage devices is assigned to each cell, and when the number of devices changes, the data records are re-allocated based on the assigned group values.

The number of re-allocated records may correspond to an amount of storage added or subtracted due to a change in the number of storage devices. When the number of storage devices corresponds to a row in the table, re-allocation is accomplished by selecting the row of the table corresponding to the changed number of storage devices, distributing the group values in the selected row among the data records so that some of the data records have new group values, and storing the data records having new group values on the devices corresponding thereto. For example, each of the records may have an associated field value (i.e., the value of a particular field of the record) and the group values may be assigned to the records based at least in part on the field values. The field values may be mapped to the group values by means of a hash function, e.g., a Pearson hash.

In some embodiments, the group values are defined as a vector of integers each corresponding to one of the storage devices. The number of integers in the vector generally exceeds the number of storage devices by some multiple, such as 64 times the number of storage devices or 100 (or more) times the number of storage devices. The group value corresponding to the device to which a record is assigned is determined by the residue of the hash function of the field value modulo the number of integers in the vector. A new vector may be computed when the number of devices changes, and at least some of the records are re-allocated in accordance with the new vector.

In some embodiments, the data records are distributed among the storage devices in a perfectly even distribution or within a predetermined variance (e.g., 10% or, more preferably, 1% or less) therefrom.

In another aspect, the invention relates to a system for allocating data records among a plurality of data storage devices in a data storage system. Embodiments of the system comprise an interface to the data storage devices and a data allocation module configured to define a series of group values based on the number of devices, assign each group value to a substantially equal number of the data records, assign one or more group values to each of the devices, and cause, via the interface, each of the data records to be stored on the device having a group value corresponding to the group value of the data record.

In still another aspect, the invention pertains to an article of manufacture having computer-readable program portions embodied thereon. The article comprises computer-readable instructions for allocating a set of data records among a plurality of data storage devices in a data storage system by defining a series of group values based on the number of devices; assigning each group value to a substantially equal number of the data records; assigning one or more group values to each of the devices in the system; and storing each of the data records on the device having a group value corresponding to the group value of the data record.

### BRIEF DESCRIPTION OF THE DRAWING

The foregoing and other objects, features and advantages of the invention will be apparent from the following more particular description of preferred embodiments of the invention, as illustrated in the single figure of the drawing, which shows a block diagram of a system implementing the approach of the present invention.

### DETAILED DESCRIPTION

The present invention provides techniques and systems for allocating records to and distributing records among a changing set of storage devices by grouping the records based on the starting and ending numbers of storage devices. In one embodiment, an allocation table is defined that directs the initial grouping and subsequent regrouping of records among storage devices as the number of storage devices changes. The table includes a series of rows each corresponding to an actual storage device or one that may possibly enter the system; that is, the number of rows corresponds to the maximum number of devices that may be present in the system. For example, if the number of devices can vary from 1 to 4, the table will include four rows, one for each possible arrangement (one device, two devices, three devices, and four devices). In some instances (e.g., disk failure, power loss, catastrophic failure, etc.), the number of devices as used herein may refer to “active devices” available on the system, so that the number of devices with corresponding rows in the table may, at any one time, be fewer than the total number of devices actually attached to the system.

The number of columns in the table corresponds to the least common multiple (LCM) of each possible number of devices. In the exemplary table below in which there may be up to four devices, the table contains four rows (reflecting the possibility that there may be one, two, three or four devices) and 12 columns (since 12 is the LCM of 1, 2, 3 and 4). Similarly, a system of eight devices results in a table of eight rows and 840 columns (the LCM of 1, 2, 3, 4, 5, 6, 7 and 8), and for 15 devices, 15 rows and 360,360 columns.

TABLE 1
Allocation Table for Four Devices

| | | | | | | | | | | | | |
|---|---|---|---|---|---|---|---|---|---|---|---|---|
| 1 device: | 0 | 0 | 0 | 0 | 0 | 0 | 0 | 0 | 0 | 0 | 0 | 0 |
| 2 devices: | 0 | 1 | 0 | 0 | 0 | 1 | 1 | 1 | 0 | 1 | 0 | 1 |
| 3 devices: | 0 | 1 | 2 | 0 | 0 | 1 | 2 | 1 | 0 | 1 | 2 | 2 |
| 4 devices: | 0 | 1 | 2 | 3 | 0 | 1 | 2 | 3 | 0 | 1 | 2 | 3 |

The table is constructed as follows. In the last row (row D) corresponding to the maximum number of storage devices, each cell in the table receives a value in the sequence from 0 to (D−1) starting with the first column. In this example, D=4, SO the sequence 0, 1, 2, 3 is written to the first four cells of the last row, and then to each subsequent set of four cells in the row. The cells of the remaining rows are populated as follows. For a remaining row R, the contents of the first R×(R+1) cells of the underlying row (i.e., row R+1) are copied into the first R×(R+1) cells of row R. The values of cells whose column number (starting from 0) modulo (R+1) is R are then changed to values in the set of numbers from 0 to (R−1). For example, the R^{th} cell could have the value 0, the 2×R^{th} cell could have the value 1, and so on so that the (R−1)^{th}×R^{th} cell could have the value R−1. This sequence of R×(R+1) values is then copied into each subsequent set of R×(R+1) cells in row R. In the example Table 1 above, the 3^{rd} row could be constructed by copying the 4^{th} row, and changing the value in 4^{th} column to 0, the value in 8^{th} column to 1 and the value in the 12^{th} column to 2. Accordingly, the distribution of values, in cells whose column number modulo R+1 is R, evenly includes values ranging from 0 to R−1.

Using this approach, for any row 1 in a table with C columns, there are (C/I) occurrences of each value in the set of numbers from 0 to (I−1). For example, in the table above having 12 columns, row 3 has 12/3=4 occurrences each of the numbers 0, 1, and 2. This even distribution avoids data skew, as shown below. Furthermore, for two

$$\frac{I}{I + 1}$$

consecutive rows I and I+1, a fixed proportion of column values stays the same, and a fixed proportion

$$\frac{1}{I + 1}$$

of column values differs. The proportion that differs corresponds to those record groups that are to be redistributed from one storage device to another, as shown below.

The third row of this table may be used to assign and/or distribute records among three storage devices according to the value of a particular field of each record, such as a character string, numerical value, decimal field or some combination thereof using the table described above. In particular, the field value determines, at least in part, the group value (and hence, ultimately, the storage device) to which a record is assigned, as the following example illustrates.

First, the field value(s) may be converted into a numeric value using, for example, a hash function H applied to the field value(s). In instances where the field is a text field containing a customer name, the hash function may add together the ASCII character values of each character in the customer name. The particular hashing function used for this purpose is not critical to the invention, so long as the same hashing function is used consistently, although hash functions that produce even distributions of resulting numbers are preferred. One example of such a function is the well-known Pearson hash, which uses a permutation lookup table to transform an input consisting of any number of bytes into a single-byte output that is strongly dependent (see Peter K. Pearson, “Fast Hashing of Variable-Length Text Strings,” Communications of the ACM 33(6):677 (1990), incorporated by reference herein). Here, a target column is determined by computing H(field value) modulo C, where C is the number of columns in the table. The target row is the one corresponding to the current number of devices. The group to which the record is assigned corresponds to the value in the cell where the target row crosses the target column. As a result, the new record is sent to the storage device to which that group is assigned.

To transition from one number of storage devices to another, records are redistributed from existing storage devices to new (or remaining) storage devices. For example, when transitioning from three devices to four, 25% of the records on each existing device are redistributed among the new set of four devices, leaving the original three devices with 75% of their previous total number of records. (This assumes the new device is empty. If it contains data, some of its contents will be re-allocated as well, and the original three devices will shed less than 25% of their pre-existing records. But because a newly added device ordinarily will not contain data, the ensuing discussion presumes an initially empty fourth device.) Using the allocation table above, redistribution is effectuated on each device by first examining each record and recalculating the record's target storage device using the technique described above, with the exception that the row number corresponding to the new number of devices (four, in this example) is used.

During the process, records with hash values corresponding to the 4th column in the table change from target group 0 to target group 3. Similarly, records having hash values that select for the 8th column in the table change from target group 1 to 3, and records having hash values that select for the 12^{th} column in the table change from target group 2 to group 3. These changes identify those records that are to be moved from each of the three existing storage devices to the new storage device.

In addition to guaranteeing even distribution of records across a new number of storage devices while minimizing the number of records being moved, this technique maintains the functional determination discussed above. For example, given a SQL query of the form:

“select * from mytable where customer_name=‘smith’”

an MPP-DB can direct the query to the only storage device that could possibly contain records in which the customer_name field equals ‘smith.’ Using the techniques described above, the string ‘smith’ is hashed using the same hash function used during the initial distribution. The residue of H(‘smith’) modulo C (where C is the number of columns in the table) maps to a column in the table above, and the value in that column along the row corresponding to numStorageDevices indicates the unique storage device that could possibly contain records having a value of ‘smith’ in the pertinent field.

In certain embodiments, the specific ordering of values in the table is not crucial to avoiding skew, minimizing record movement, and retaining functional determination. For example, the first four column values of the 4th row in the table above might contain {3, 2, 1, 0} instead of {0, 1, 2, 3}, so long as each number in the set is represented in the row the same number of times. In a preferred embodiment, the row values can be calculated at runtime, and as a result, the entire table need not be determined and stored.

In some implementations, the requirement for achieving or maintaining a perfectly even distribution among the devices may be relaxed by some acceptable threshold. For example, in a system having an anticipated maximum number of storage devices MaxD, a table may be defined having 100×MaxD columns. In such a case, even though there are fewer columns than would be prescribed using the LCM of (1 . . . MaxD) as described above, the variance from a perfectly even distribution is typically less than 1%. The processing and storage gains achieved by eliminating columns may outweigh any incremental gains in data-access speed realized by a perfect distribution. Accordingly, the relaxation threshold—e.g., the number of columns less than that dictated by the LCM—may be set such that so as to set an upper limit the skew percentage, e.g., so that the decrease in data-access speed relative to that achievable with a perfect distribution does not exceed a desired percentage (e.g., 1%). These same techniques may be used to redistribute records when the number of storage devices is reduced.

The preceding techniques start by calculating the data groupings for the final row based on the maximum anticipated number of storage devices and, based on this maximum number, obtaining the groupings for the preceding rows that reflect a smaller and/or initial number of devices. In another embodiment (which also may employ a hash function for partitioning), the LCM approach is implemented in a slightly different manner that does not rely on knowing, a priori, the maximum number of storage devices. Instead, a vector of integers is used in which each integer represents a particular storage device. In instances in which there are I initial storage devices, each of the numbers from 0 to (I−1) occurs once in each group of I elements in the vector. If, however, the size of the vector is not an exact multiple of I, the distribution of records across storage devices will not be exactly even. Therefore, the size of the vector (maxSizeOfVector) should be much larger than the number of storage devices (e.g., 100I, for a 1% variance from a perfectly even distribution). The value of each element of the vector can be determined in many ways; one suitable approach is to assign to the element at position n in the vector the value of the residue of (n modulo I), where n is between 0 and maxSizeOfVector.

The vector may then be used to assign records to storage devices in the manner described above. A field in the record, chosen to direct the distribution, is hashed into a number via a hash function H. The residue of (H(field value) modulo maxSizeOfVector) is then used to find an element in the vector, which identifies the target device for the record.

When changing the number of storage devices from the initial number I to a final number F, a new vector is computed. For example, one approach for calculating the new vector includes the following steps:
1. Compute the LCM of the initial and the final number of storage devices.
2. Compute the number of times numNewReps a new storage device identifier (integers between I and (F−1)) should appear in a group of LCM elements in the vector as LCM/F.
3. Compute the number of times numOldReps an existing storage device identifier (integers between 0 and (I−1)) should appear in a group of LCM elements in the vector as LCM/1.
4. Compute the number of times numOldMods a given existing storage device identifier (integers between 0 and (I−1)) is changed to a new storage device identifier (integers between I and (F−1)) as numOldReps−((LCM−numNewReps×(F−I))/I).

In each sequence of LCM elements of the vector, the original storage device identifiers are represented LCM/I times, and the new storage device identifiers are represented LCM/F times. Therefore, the desired regrouping is achieved by iterating over the sequence of LCM elements while replacing numOldMods of instances of each element in the series {0 . . . (I−1)} in the existing vector with numNewReps occurrences of values in the range {I . . . (F−1)} for each sequence.

In a third embodiment, the number of record groupings is defined as the LCM of (a) the number of initial storage devices and (b) a set of some possible target numbers of storage devices. Several such groupings are mapped to each initial storage device. Later, when storage devices are added in sufficient numbers to equal one of the possible target numbers of devices, some of the groupings on each pre-existing storage device are redistributed in their entireties to the new storage devices in accordance with the corresponding grouping. Similarly, when storage devices are removed, the groupings on the devices being removed are redistributed in their entireties to the remaining storage devices in accordance with the grouping corresponding to the diminished number of devices.

This embodiment of the invention may be used either with hash-based distributions or round-robin creation-time distributions. If the records in a group are stored sequentially on disk, then when the groups are redistributed in their entireties, the storage devices are left without holes or fragmentation. Also, because the elements of a group are not clustered by order of creation, redistribution of a group will not introduce age-based data skew.

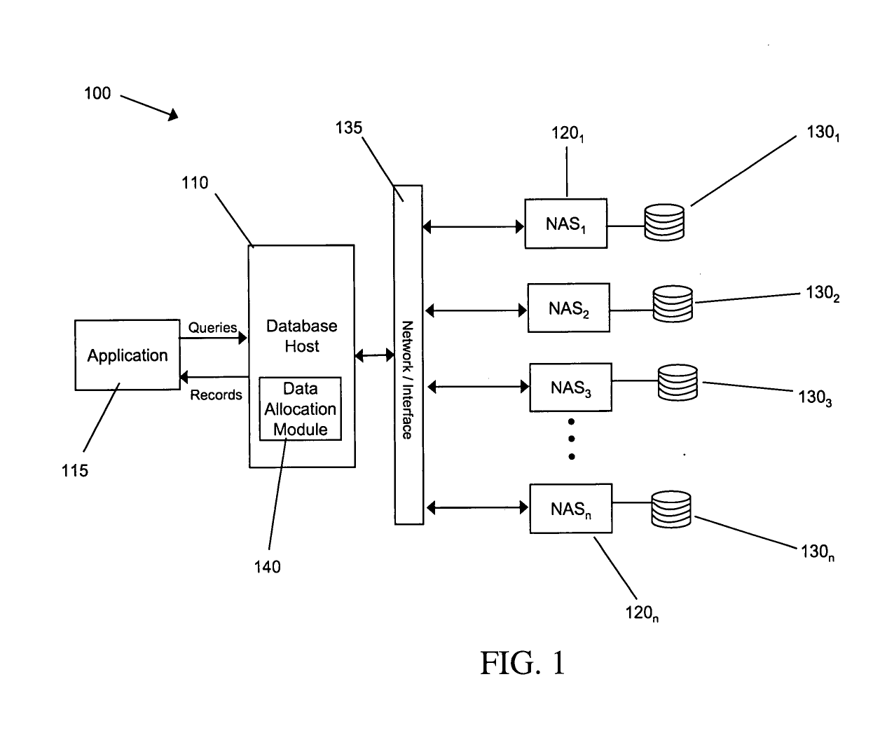

The methods and techniques describe above may be implemented in hardware and/or software and realized as a system for allocating and distributing data among storage devices. For example, the system may be implemented as a data-allocation module within a larger data storage appliance (or series of appliances). Thus, a representative hardware environment in which the present invention may be deployed is illustrated in FIG. 1.

The illustrated system 100 includes a database host 110, which responds to database queries from one or more applications 115 and returns records in response thereto. The application 115 may, for example, run on a client machine that communicates with host 110 via a computer network, such as the Internet. Alternatively, the application may reside as a running process within host 110.

Host 110 writes database records to and retrieves them from a series of storage devices, illustrated as a series of NAS appliances 120. It should be understood, however, that the term “storage device” encompasses NAS appliances, storage-area network systems utilizing RAID or other multiple-disk systems, simple configurations of multiple physically attachable and removable hard disks or optical drives, etc. As indicated at 125, host 110 communicates with NAS appliances 120 via a computer network or, if the NAS appliances 120 are physically co-located with host 110, via an interface or backplane. Network-based communication may take place using standard file-based protocols such as NFS or SMB/CIFS. Typical examples of suitable networks include a wireless or wired Ethernet-based intranet, a local or wide-area network (LAN or WAN), and/or the Internet.

NAS appliances 120₁, 120₂ . . . 120ₙ each contain a plurality of hard disk drives 130₁, 130₂ . . . 130ₙ. The number of disk drives 130 in a NAS appliance 120 may be changed physically, by insertion or removal, or simply by powering up and powering down the drives as capacity requirements change. Similarly, the NAS appliances themselves may be brought online or offline (e.g., powered up or powered down) via commands issued by controller circuitry and software in host 110, and may be configured as “blades” that can be joined physically to the network as capacity needs increase. The NAS appliances 120 collectively behave as a single, variable-size storage medium for the entire system 100, meaning that when data is written to the system 100, it is written to a single disk 130 of a single NAS appliance 120.

Host 110 includes a network interface that facilitates interaction with client machines and, in some implementations, with NAS appliances 120. The host 110 typically also includes input/output devices (e.g., a keyboard, a mouse or other position-sensing device, etc.), by means of which a user can interact with the system, and a screen display. The host 110 further includes standard components such as a bidirectional system bus over which the internal components communicate, one or more non-volatile mass storage devices (such hard disks and/or optical storage units), and a main (typically volatile) system memory. The operation of host 100 is directed by its central-processing unit (“CPU”), and the main memory contains instructions that control the operation of the CPU and its interaction with the other hardware components. An operating system directs the execution of low-level, basic system functions such as internal memory allocation, file management and operation of the mass storage devices, while at a higher level, a data allocation module 135 performs the allocation functions described above in connection with data stored on NAS appliances 120, and a storage controller operates NAS appliances 120. Host 110 maintains an allocation table so that, when presented with a data query, it “knows” which NAS appliance 120 to address for the requested data.

Data allocation module 135 may in some cases also include functionality that allows a user to view and/or manipulate the data allocation process. In some embodiments the module may set aside portions of a computer's random access memory to provide control logic that affects the data allocation process described above. In such an embodiment, the program may be written in any one of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software could be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

The present invention provides several benefits and advantages over prior art systems for distributing records among storage devices in a massively parallel processing database management system. The invention allows for the redistribution of records across scalable storage, with minimal movement and skew-avoidance. Through its record grouping choices, the invention maintains determinacy (the ability to locate a record's storage device by examining the record's attributes), and avoids storage fragmentation and the introduction of query-based skew.

Variations, modifications, and other implementations of what is described herein will occur to those of ordinary skill in the art without departing from the spirit and the scope of the invention as claimed.

1. A method of allocating a set of data records among a plurality of data storage devices in a data storage system, the method comprising:
defining a series of group values based on the number of devices;
assigning each group value to a substantially equal number of the data records;
assigning each group value to one of the devices in the system;
storing each of the data records on the device having a group value corresponding to the group value of the data record; and
when the number of storage devices changes, re-allocating some of the records among storage devices based on the group values.

2. The method of claim 1 further comprising:
defining a record allocation table comprising a plurality of cells, each cell representing an intersection of one of N rows and M columns, wherein N equals a maximum possible number of storage devices in the system and M equals the lowest common multiple of a series of numbers from 1 to N;
assigning one of the group values in the series to each cell; and
when the number of storage devices changes, the re-allocating step is performed based on the table.

3. The method of claim 2 wherein the number of re-allocated records corresponds to an amount of storage added or subtracted due to the change in the number of storage devices.

4. The method of claim 2 wherein the number of storage devices corresponds to a row in the table, the step of re-allocating the records comprising:
selecting the row of the table corresponding to the changed number of storage devices;
distributing the group values in the selected row among the data records so that some of the data records have new group values; and
storing the data records having new group values on the devices corresponding thereto.

5. The method of claim 2 wherein the cell values are calculated at runtime.

6. The method of claim 1 wherein a plurality of group values may be assigned to a single storage device.

7. The method of claim 1 wherein all data records corresponding to a group value may be moved to a single storage device.

8. The method of claim 1 wherein each of the records has a field value and the group values are assigned to the records based at least in part on the field values.

9. The method of claim 8 wherein the field values are mapped to the group values by means of a hash function.

10. The method of claim 9 wherein the hash function is a Pearson hash.

11. The method of claim 1 wherein the data records are distributed among the storage devices within a predetermined variance from a perfectly even distribution.

12. The method of claim 11 wherein the variance is 10% or less.

13. The method of claim 12 wherein the variance is 1% or less.

14. A method of allocating a set of data records among a plurality of data storage devices in a data storage system, the method comprising:
defining a series of group values based on the number of devices;
assigning each group value to a substantially equal number of the data records;
assigning each group value to one of the devices in the system; and
storing each of the data records on the device having a group value corresponding to the group value of the data record, wherein the group values are defined as a vector of integers each corresponding to one of the storage devices, the number of integers in the vector exceeding the number of storage devices.

15. The method of claim 14 wherein:
each of the records has a field value and the group values are assigned to the records based at least in part on the field values;
the field values are mapped to the group values by means of a hash function; and
the group value corresponding to the device to which a record is assigned is determined by the residue of the hash function of the field value modulo the number of integers in the vector.

16. The method of claim 15 further comprising the step of computing a new vector when the number of devices changes and re-allocating at least some of the records in accordance with the new vector.

17. The method of claim 16 wherein the step of computing a new vector comprises the steps of:
(a) computing the least common multiple of an initial and final number of storage devices;
(b) computing a number of times a new group value appears in a sequence of length is equal to the least common multiple;
(c) computing a number of times an existing group value appears in a sequence whose length is the least common multiple; and
(d) computing a number of times an existing group value is changed to a new group value.

18. The method of claim 14 wherein the size of the vector of integers is at least ten times larger than the number of storage devices.

19. A system for allocating data records among a plurality of data storage devices in a data storage system, the system comprising:
an interface to the data storage devices; and
a data allocation module configured (i) to define a series of group values based on the number of devices, (ii) to assign each group value to a substantially equal number of the data records, (iii) to assign one or more group values to each of the devices, (iv) to cause, via the interface, each of the data records to be stored on the device having a group value corresponding to the group value of the data record, and (v) when the number of storage devices changes, to re-allocate some of the records among storage devices based on the group values.

20. The system of claim 19 wherein the data allocation module comprises a record-allocation table including a plurality of cells, each cell representing an intersection of one of N rows and M columns, wherein N equals a maximum possible number of storage devices in the system and M equals the lowest common multiple of a series of numbers from 1 to N, the data allocation module being configured to assign one of the group values in the series to each cell, and when the number of storage devices changes, re-allocating is performed based on the table.

21. The system of claim 20 wherein the number of re-allocated records corresponds to an amount of storage added or subtracted due to the change in the number of storage devices.

22. The system of claim 20 wherein the number of storage devices corresponds to a row in the table, the data allocation module re-allocating the records by (i) selecting the row of the table corresponding to the changed number of storage devices, (ii) distributing the group values in the selected row among the data records so that some of the data records have new group values, and (iii) storing the data records having new group values on the devices corresponding thereto.

23. The system of claim 19 wherein each of the records has a field value and the data allocation module assigns group values to the records based at least in part on the field values.

24. The system of claim 23 wherein the data allocation module maps field values to the group values by means of a hash function.

25. The system of claim 24 wherein the hash function is a Pearson hash.

26. A system for allocating data records among a plurality of data storage devices in a data storage system, the system comprising:
an interface to the data storage devices; and
a data allocation module configured (i) to define a series of group values based on the number of devices, (ii) to assign each group value to a substantially equal number of the data records, (iii) to assign one or more group values to each of the devices, and (iv) to cause, via the interface, each of the data records to be stored on the device having a group value corresponding to the group value of the data record, wherein the group values are defined as a vector of integers each corresponding to one of the storage devices, the number of integers in the vector exceeding the number of storage devices.

27. The system of claim 26 wherein the data allocation module computes a new vector when the number of devices changes and re-allocating at least some of the records in accordance with the new vector.

28. An article of manufacture having computer-readable program portions embodied thereon, the article comprising computer-readable instructions for allocating a set of data records among a plurality of data storage devices in a data storage system by:
defining a series of group values based on the number of devices;
assigning each group value to a substantially equal number of the data records;
assigning one or more group values to each of the devices in the system;
storing each of the data records on the device having a group value corresponding to the group value of the data record; and
when the number of storage devices changes, re-allocating some of the records among storage devices based on the group values.

29. An article of manufacture having computer-readable program portions embodied thereon, the article comprising computer-readable instructions for allocating a set of data records among a plurality of data storage devices in a data storage system by:
defining a series of group values based on the number of devices;
assigning each group value to a substantially equal number of the data records;
assigning one or more group values to each of the devices in the system;
storing each of the data records on the device having a group value corresponding to the group value of the data record, wherein the group values are defined as a vector of integers each corresponding to one of the storage devices, the number of integers in the vector exceeding the number of storage devices.
